(19) United States
(12) Patent Application Publication
(10) Pub. No.: US 2021/0099745 A1
(43) Pub. Date: Apr. 1, 2021

(54) DISPLAY APPARATUS AND CONTROLLING METHOD OF DISPLAY APPARATUS

(71) Applicant: SAMSUNG ELECTRONICS CO., LTD., Suwon-si (KR)

(72) Inventor: Daehyun LEE, Suwon-si (KR)

(73) Assignee: SAMSUNG ELECTRONICS CO., LTD., Suwon-si (KR)

(21) Appl. No.: 17/023,692

(22) Filed: Sep. 17, 2020

(30) Foreign Application Priority Data
Oct. 1, 2019 (KR) 10-2019-0121490

(51) Int. Cl. H04N 21/262; H04N 21/2187; H04N 21/472; H04N 21/81; H04N 21/2668

(52) U.S. Cl. CPC H04N 21/26258; H04N 21/2187; H04N 21/2668; H04N 21/812; H04N 21/26283; H04N 21/47217

(57) ABSTRACT

A display apparatus includes a display, a communicator, a memory storing a broadcast schedule table and a processor configured to, based on a channel being selected, identify whether a broadcast content scheduled at a current time is present on a broadcasting schedule of the selected channel in the broadcast schedule table, and based on the broadcast content being present, control the communicator to receive, from a server, the broadcast content from a time of playback corresponding to the current time in a streaming method, and control the display to playback the broadcast content, and based on the broadcast content not being present, identify an empty schedule period starting from the current time, identify one of a plurality of contents based on the empty schedule period and playback times of the plurality of contents, and control the display to playback the identified content.

### CROSS-REFERENCE TO RELATED APPLICATION

This application is based on and claims priority under 35 U.S.C. § 119 to Korean patent application number 10-2019-0121490, filed on Oct. 1, 2019, in the Korean Intellectual Property Office, the disclosure of which is incorporated by reference herein in its entirety.

### BACKGROUND

### 1. Field

The disclosure relates to a display apparatus and a controlling method of a display apparatus, and more specifically to a display apparatus displaying live streaming broadcast content and a control method of the display apparatus displaying the live streaming broadcast content.

### 2. Description of Related Art

Live streaming broadcast service (i.e., it may also be referred to as streaming TV service, online TV service, internet TV service, or the like) may refer to a service in which an online channel is configured to be provided to a user similar to a typical TV broadcast (e.g., terrestrial broadcast, cable broadcast, satellite broadcast, etc.) by having been allocated a TV channel and registering a broadcast program schedule information of the allocated channel as an online broadcasting schedule.

When using a live streaming broadcast service such as the above, cases such as there being no scheduled program at a current time on a broadcast schedule table for whatever reason or there being a scheduled program at the current time but not being able to playback the program may arise. In addition, cases of a playback time of an actual content being extended than the schedule on the broadcasting schedule table may also arise.

Like the above, when a schedule is empty on the broadcast schedule table or when content may not be played back according to the broadcast schedule table, it may become problematic and may cause inconvenience or confusion to a user.

### SUMMARY

According to an embodiment, a display apparatus includes a display, a communicator, a memory storing a broadcast schedule table including a broadcasting schedule for each channel of a live streaming broadcast service and a content list on a plurality of contents with playback times of different lengths, and a processor configured to, based on selecting a channel to which the live streaming broadcast service is provided, identify whether a broadcast content scheduled at a current time is present on a broadcasting schedule of the selected channel in the broadcast schedule table, and based on the broadcast content being present, control the communicator to receive, from a server providing the broadcast content, the broadcast content from a time of playback corresponding to the current time of a total playback time of the broadcast content in a streaming method, and control the display to playback the broadcast content received in a streaming method, and the processor is configured to, based on the broadcast content not being present, identify an empty schedule period that starts from the current time on the broadcasting schedule of the selected channel, identify one of the plurality of contents based on the empty schedule period and playback times of the plurality of contents included in the content list, and control the display to playback the identified content.

The processor may be configured to identify one content with a playback time of a length corresponding to the empty schedule period among the plurality of contents, and control the display to playback the identified content at the empty schedule period.

The processor may be configured to identify whether a broadcast content in which the current time is between a playback start time and a playback end time on the broadcasting schedule of the selected channel is present to identify whether the broadcast content scheduled at the current time is present.

The processor may be configured to, based on the broadcast content not being present, identify a period from the current time to a playback start time of a next broadcast content with a closest playback start time based on the current time as the empty schedule period on the broadcasting schedule of the selected channel.

The processor may be configured to, based on the broadcast content being present on the broadcasting schedule of the selected channel but not being able to playback the broadcast content, identify the empty schedule period, and control the display to playback the identified content at the empty schedule period.

The processor may be configured to, based on a server providing the broadcast content being in plurality, identify whether the broadcast content is receivable from a plurality of servers based on a priority order on the plurality of servers, and based on not being able to receive the broadcast content from the plurality of servers, determine the broadcast content as not being able to playback.

The identified content may be at least one of an advertisement image content, a promotional image content on a channel selected by an administrator of a server that manages the broadcast schedule table among the plurality of promotional image contents promoting each channel of the live streaming broadcast service, and a use guide image content of the display apparatus.

The processor may be configured to, while playing back the received broadcast content on the display, when a playback start time of a broadcast content scheduled in following order of the received broadcast content on the broadcasting schedule of the selected channel arrives within a predetermined time range from the current time, identify a playback end time of the received broadcast content, and based on the playback end time being later than a playback start time of the next scheduled broadcast content, control the display to display a user interface (UI) inquiring whether to view or record the next scheduled broadcast content.

The processor may be configured to, based on completing playback of the received broadcast content, identify whether a broadcast content scheduled after the completion of the playback is present on the broadcasting schedule of the selected channel on the broadcast schedule table.

According to an embodiment, a control method of a display apparatus includes, based on selecting a channel to which live streaming broadcast service is provided, identifying whether a broadcast content scheduled at a current time is present on the broadcasting schedule of the selected channel in a broadcast schedule table which includes the broadcasting schedules for each channel of the live streaming broadcast service, and based on the broadcast content being present, receiving, from a server providing the broadcast content, the broadcast content from a time of playback corresponding to the current time of a total playback time of the broadcast content in a streaming method and playing back the received broadcast content, and based on the broadcast content not being present, identifying an empty schedule period that starts from the current time on the broadcasting schedule of the selected channel, identifying one of a plurality of contents based on the empty schedule period and a playback time of the plurality of contents with playback times of different lengths from one another, and playing back the identified content.

According to an embodiment, a non-transitory computer readable recording medium including a program for executing a control method of a display apparatus is provided where the method includes, based on selecting a channel to which a live streaming broadcast service is provided, identifying whether a broadcast content scheduled at a current time is present on a broadcasting schedule of the selected channel in a broadcast schedule table which includes a broadcasting schedules for each channel of the live streaming broadcast service, and based on the broadcast content being present, receiving, from a server providing the broadcast content, the broadcast content from a time of playback corresponding to the current time of a total playback time of the broadcast content in a streaming method and playing back the received broadcast content, and based on the broadcast content not being present, identifying an empty schedule period that starts from the current time on the broadcasting schedule of the selected channel, and identifying one of a plurality of contents based on the empty schedule period and playback times of the plurality of contents with playback times of different lengths from one another and playing back the identified content.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is an exemplary view illustrating a live streaming broadcast system according to an embodiment of the disclosure;

FIG. 2 is block diagram illustrating a display apparatus according to an embodiment of the disclosure;

FIG. 3A is an exemplary view illustrating a broadcast schedule table according to an embodiment of the disclosure;

FIG. 3B is an exemplary view illustrating a content list according to an embodiment of the disclosure;

FIG. 4A is an exemplary view illustrating an advertisement image content according to an embodiment of the disclosure;

FIG. 4B is an exemplary view illustrating a channel promoting image content according to an embodiment of the disclosure;

FIG. 4C is an exemplary view illustrating a use guide image content of a display apparatus according to an embodiment of the disclosure;

FIG. 5 is an exemplary view illustrating a UI inquiring whether to view or record according to an embodiment of the disclosure;

FIG. 6 is a flowchart illustrating a control method of a display apparatus according to an embodiment of the disclosure; and

FIG. 7 is a flowchart illustrating a control method of a display apparatus according to another embodiment of the disclosure.

### DETAILED DESCRIPTION

In describing the disclosure, a detailed description of the related art may be omitted when it is determined that the detailed description may unnecessarily obscure the gist of the disclosure. In addition, redundant descriptions of the same configuration will be omitted.

The suffix “part” for an element used herein may be added or mixed therein only for the consideration of ease of writing the specification, and does not have a distinct meaning or role as it is.

The terms used herein are used for describing various embodiments, and not intended for limiting and/or restricting the disclosure. A singular expression may include a plural expression, unless otherwise specified.

It should be understood that terms such as “comprise” or “consist of” used herein are to designate a presence of a characteristic, a number, a function, a step, an operation, an element, a component, or the combination thereof, and not to preclude a presence or a possibility of adding one or more of other characteristics, numbers, steps, operations, elements, components, or a combination thereof.

The expressions such as “first” and “second” may be used to modify various elements, regardless of order and/or importance. The terms are used only for the purpose of distinguishing one element from another, and the corresponding element is not limited thereto.

When a certain element (e.g., first element) is indicated as being “(operatively or communicatively) coupled with/to” or “connected to” another element (e.g., second element), it may be understood as the certain element being directly coupled with/to the other element or as being coupled through still another element (e.g., third element). On the other hand, when a certain element (e.g., first element) is indicated as “directly coupled with/to” or “connected to” another element (e.g., second element), it may be understood as a still another element (e.g., third element) not being present between the certain element and the other element.

The terms used in the various embodiments herein may be interpreted to commonly known meanings by those of ordinary skill in the art, unless otherwise specified.

The disclosure provides a display apparatus capable of minimizing user inconvenience or confusion by providing a live streaming broadcast service while maintaining a broadcast schedule table even when a schedule is empty on the broadcast schedule table or when a broadcast content may not be played back according to the broadcast schedule table, and a control method of a display apparatus.

Various embodiments of the disclosure will be described in detail below with reference to the accompanying drawings.

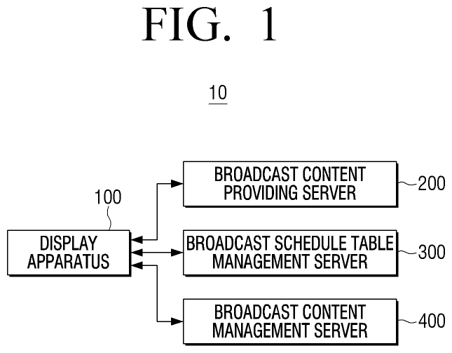

FIG. 1 is an exemplary view illustrating a live streaming broadcast system according to an embodiment of the disclosure. Referring to FIG. 1, the live streaming broadcast system 10 may include a display apparatus 100, a broadcast content providing server 200, a broadcast schedule table management server 300, and a broadcast content management server 400.

As described above, the live streaming broadcast service may refer to a service configured so that an allocated channel may be provided to a user like a typical TV broadcast by registering a broadcasting schedule information of an allocated channel as a broadcast schedule table.

The broadcast schedule table management server 300 may generate and manage a broadcast schedule which includes a broadcasting schedule for each channel of the live streaming broadcast service. Specifically, an administrator of the broadcast schedule table management server 300 may schedule a broadcasting schedule of at least one allocated live streaming channel, and may generate and manage a broadcast schedule table based on the broadcasting schedule. The broadcast schedule table generated as described above may be managed by the broadcast schedule table management server 300, and provided to the display apparatus 100 when there is a request from the display apparatus 100. The broadcast schedule table may, at this time, include information on a playback start time and a playback end time of a broadcast content (i.e., broadcast program) scheduled at a corresponding channel, like an electronic program guide (EPG).

The broadcast schedule table management server 300 may, with respect to each of a plurality of broadcast contents included in the broadcast schedule table, further manage a location information (e.g., uniform resource locator (URL) information) of the broadcast content providing server 200 that provides the corresponding broadcast content. The location information of the broadcast content providing server 200 together with the broadcast schedule table may be provided to the display apparatus 100, but the embodiment is not limited thereto.

The broadcast content providing server 200 may store and manage at least one live streaming broadcast content. Specifically, the broadcast content providing server 200 may provide a broadcast content requested by the display apparatus 100 from the time of the playback requested by the display apparatus 100 to the display apparatus 100 in a streaming method.

In addition, the broadcast content providing server 200 may include a unique location information for the display apparatus 100 to be connected to the broadcast content providing server 200, based on the location information of the broadcast content providing server 200 obtained from the broadcast schedule table management server 300.

In FIG. 1, only one broadcast content providing server 200 has been illustrated for convenience of illustration, but the broadcast content providing server 200 that manages the broadcast contents included in the broadcast schedule table may be in plurality. That is, the plurality of broadcast contents included in the broadcast schedule table may be stored and managed in a plurality of broadcast content providing servers 200 different from one another.

The broadcast content management server 400 may manage various contents with playback times of different lengths from one another capable of being inserted in an empty schedule period (hereinafter, referred to as ‘insert content’), which will be described below. The content management server 400 may, based on a request by the display apparatus 100, provide at least one of a plurality of insert contents that are being managed, and also provide a content list on the plurality of insert contents that are being managed. The content list may include information on each of the plurality of insert contents and a playback time information on each of the plurality of insert contents.

The display apparatus 100 may playback various kinds of image content. Specifically, the display apparatus 100 may receive broadcast content from the broadcast content providing server 200 in a streaming method and display the received content.

In addition, the display apparatus 100 may, based on a live streaming broadcast channel being selected by a user, identify whether a broadcast content scheduled at a current time is present in the channel selected based on the broadcast schedule table received from the broadcast schedule table management server 300.

Based on a broadcast content scheduled at the current time being present, the display apparatus 100 may receive the broadcast content scheduled at the current time from the broadcast content providing server 200 and playback the received content.

Specifically, the display apparatus 100 may access the broadcast content providing server 200 based on the location information of the broadcast content providing server 200 received from the broadcast schedule table management server 300, and receive, from the broadcast content providing server 200, the broadcast content scheduled at the current time from the playback time corresponding to the current time of a total playback time of the broadcast content scheduled at the current time in a streaming method and playback the received content.

The broadcast content scheduled at the current time on the broadcast schedule table may not be present for whatever reason such as an administrator error of the broadcast schedule table management server 300. As in the above, based on the broadcast content scheduled at the current time not being present, the display apparatus 100 may identify an empty schedule period that starts from the current time on the broadcast schedule table. The empty schedule period may refer to a period between a current time and a playback start time of the next broadcast content with the fastest playback start time based on the current time, on the broadcasting schedule of the user selected channel of the broadcast schedule table.

Accordingly, the display apparatus 100 may identify an insert content with a playback time of a length corresponding to the empty schedule period among the plurality of insert contents included in the content list received from the broadcast content management server 400 and playback the identified insert content in the empty schedule period. The display apparatus 100 may receive the identified insert content from the broadcast content management server 400 in a streaming method and playback the received insert content, or if the identified insert content is pre-stored in the display apparatus, playback the pre-stored insert content.

Even if a broadcast content scheduled at the current time is present, there may be cases where the broadcast content may not be played back. According to an embodiment, the display apparatus 100 may, even in this case, identify an empty schedule, and playback an insert content with a playback time of a length corresponding to the empty schedule period in the empty schedule period.

While playing back the broadcast content scheduled at the current time, a playback start time of a broadcast scheduled in the following order of the broadcast content being played back may become imminent. According to an embodiment, the display apparatus 100 may display a user interface (UI) inquiring whether to view the next scheduled broadcast content or to continue viewing the broadcast content being played back and recording the next scheduled broadcast content before the playback start time of the next scheduled broadcast content arrives, and promote user convenience by giving the user an option to choose.

In the above, an example of the broadcast content providing server 200, the broadcast schedule table management server 300 and the broadcast content management server 400 being respectively implemented as a separate server has been described, but the embodiment is not limited thereto. For example, two or more of the broadcast content providing server 200, the broadcast schedule table management server 300 and the broadcast content management server 400 may be implemented as one server.

As described above, according to the various embodiments, even when cases of a schedule being empty on the broadcasting schedule or not being able to playback the broadcast content according to the broadcasting schedule occur, the live streaming broadcast service may be provided while maintaining the existing broadcast schedule table and user inconvenience or confusion may be minimized.

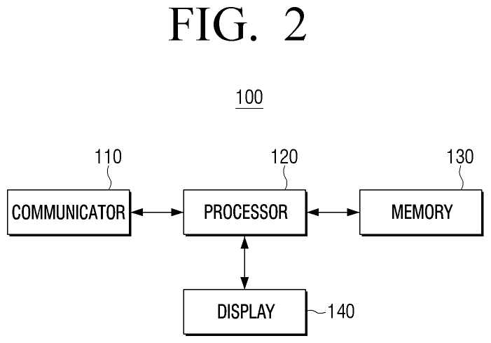

Various embodiments of the disclosure will be described in greater detail below with references to FIGS. 2 to 5.

FIG. 2 is block diagram illustrating a display apparatus according to an embodiment of the disclosure. Referring to FIG. 2, the display apparatus 100 may include a communicator 110, a processor 120, a memory 130, and a display 140.

The display apparatus 100 may be implemented as various apparatuses capable of playing back image content by including a display such as, for example, a smart television (TV), a tablet, a monitor, a smartphone, a desktop computer, a laptop computer, a navigation, and a digital signage. Accordingly, the display apparatus 100 may, based on the example, further include various other configurations necessary in the operation of an implemented apparatus in addition to the configurations illustrated in FIG. 2.

The communicator 110 may perform communication with various external apparatuses such as a server or a terminal apparatus. Specifically, the communicator 110 may perform communication with the broadcast content providing server 200, the broadcast schedule table management server 300, and the broadcast content management server 400 described in FIG. 1 above to transmit and receive various information. The communicator 110 may receive broadcast content in a streaming method from the broadcast content providing server 200.

To this end, the communicator 110 may include a wireless communicator, a wired communicator, and an input interface.

The wireless communicator may perform communication with various external apparatuses using wireless communication technology or mobile communication technology. The wireless communication technology may include, for example, Bluetooth, Bluetooth low energy, controller area network (CAN) communication, Wi-Fi, Wi-Fi direct, ultra-side band (UWB) communication, ZigBee, infrared data association (IrDA) communication, or near field communication (NFC), and 3^{rd} generation partnership project (3GPP), Wi-Max, long term evolution (LTE), 5^{th} generation (5G), and the like may be included as mobile communication technology. The wireless communicator may be implemented using an antenna capable of transmitting electromagnetic waves externally or receiving externally transmitted electromagnetic waves, a communication chip, a substrate, and the like.

The wired communicator may perform communication with various external apparatuses based on a wired communication network. The wired communication network may be implemented using a physical cable such as, for example, a pair cable, a coaxial cable, an optical fiber cable, or an Ethernet cable.

One of the wireless communicator and the wired communicator may be omitted according to the embodiment. Accordingly, the display apparatus 100 may include only the wireless communicator or the wired communicator. In addition to the above, the display apparatus 100 may include an integrated communicator which supports both a wireless connection by a wireless communicator and a wired connection by wired communicator.

The input interface may be provided so as to be able to couple with a different apparatus provided separately from the display apparatus 100, for example, an external storage apparatus. For example, the input interface may be a universal serial bus (USB) terminal, and may include at least one of the terminals for various interfaces such as high definition multimedia interface (HDMI) terminal or Thunderbolt terminal.

The memory 130 may store various programs or data temporarily or non-temporarily, and may transfer the stored data to the processor 120 based on a call by the processor 120. In addition, the memory 130 may store various information necessary in the calculation, processing, control operation, or the like of the processor 120 in an electronic format.

For example, the memory 130 may store all or some of the various data, application, filter, algorithm, or the like necessary in the operation of the processor 120, and may provide the above to the processor 120 based on necessity. The application may be an application obtained through an electronic software distribution network capable of connecting through the communicator 110.

The memory 130 may include, for example, at least one of a main memory apparatus and an auxiliary memory apparatus. The main memory apparatus may be implemented using semiconductor storing mediums such as a read only memory (ROM) and/or random access memory (RAM). The ROM may include, for example, a conventional ROM, an erasable programmable ROM (EPROM), an electrically erasable programmable ROM (EEPROM), and/or a MASK-ROM. The RAM may include, for example, a dynamic RAM (DRAM) and/or a static RAM (SRAM). The auxiliary memory apparatus may be implemented using at least one storage medium capable of permanently or semi-permanently storing data such as a flash memory apparatus, a secure digital (SD) card, a solid state drive (SSD), a hard disc drive (HDD), a magnetic drum, a compact disc (CD), a digital versatile disc (DVD), or an optical recording medium like a laser disc, a magnetic tape, an magneto-optical disk, and/or floppy disk.

Specifically, the memory 130 may store the broadcast schedule table received from the broadcast schedule table management server 300, the location information of the broadcast content providing server 200, the insert content received from the broadcast content management server 400, the content list, and the like.

The display 140 may display various images. Specifically, the display 140 may display the broadcast content provided from the broadcast content providing server 200 in a streaming method.

The display 140 may include display panels of various types such as a liquid crystal display (LCD) panel, an organic light emitting diode (OLED) panel, a plasma display panel (PDP), an in-organic LED panel, a micro LED panel, and the like, but the embodiment is not limited thereto. The display 140 may be configured with a touch screen in addition to the touch panel.

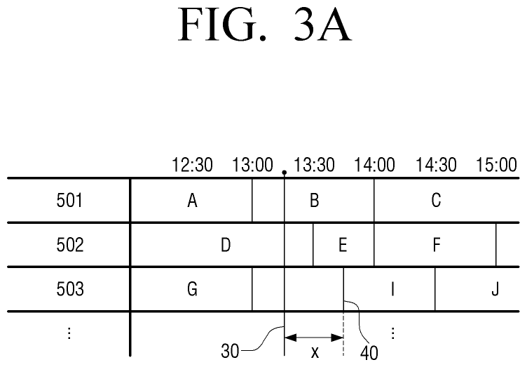

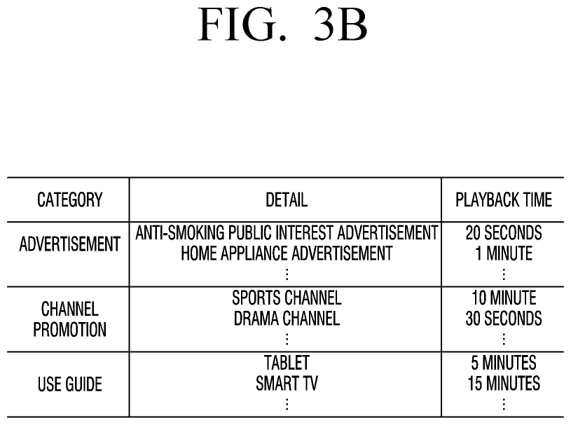

The processor 120 may control the overall operation of the display apparatus 100. The operation of the processor 120 will be described below with reference to FIGS. 3A and 3B. FIG. 3A is an exemplary view illustrating a broadcast schedule table according to an embodiment of the disclosure. In FIG. 3A, reference numerals 501, 502 and 503 indicate live streaming broadcasting channels, and 12:30 to 15:00 indicate time, and A to J indicate live streaming broadcast content scheduled on the broadcast schedule table. Meanwhile, reference numeral 30 indicates the current time.

The processor 120 may, based on selecting a channel to which a live streaming broadcast service is provided by a user, identify whether the broadcast content scheduled at the current time on the broadcasting schedule of the selected channel in the broadcast schedule table received from the broadcast schedule table management server 300 is present.

The case of the channel to which a live streaming broadcast service is provided being selected by the user may include a case of the user directly adjusting the channel to select the live streaming broadcast service channel of a general TV broadcasting service channel and the live streaming broadcast service channel, and a case of the live streaming broadcast service channel played back being stored when the power of the display apparatus 100 is turned-off and automatically selected as the power of the display apparatus is turned-on.

Specifically, the processor 120 may identify whether a broadcast content with a current time included in-between the playback start time and the playback end time is present on the broadcasting schedule of the selected channel to identify whether the broadcast content scheduled at the current time is present.

Based on the identification, if the broadcast content scheduled at the current time is present, the processor 120 may be configured to control the communicator 110 to receive, from the broadcast content providing server 200, the broadcast content from a time of playback corresponding to the current time of a total playback time of the broadcast content scheduled at the current time in a streaming method, and control the display 140 to playback the broadcast content received in a streaming method.

For example, in FIG. 3A, when channel number 501 is selected, the processor 120 may identify whether a broadcast content B with a current time 30 (e.g., 13:15) included in-between 13:00 (i.e., playback start time) and 14:00 (i.e., playback end time) is present on the broadcasting schedule of the channel number 501 to identify whether the broadcast content B scheduled at the current time 30 is present.

Accordingly, the processor 120 may control the communicator 110 to receive, from the broadcast content providing server 200 providing the broadcast content B, the broadcast content B from a time of playback corresponding to the current time 30 (e.g., 13:15) in a streaming method, and playback the broadcast content B received in a streaming method through the display 140.

Specifically, the processor 120 may, based on identifying the broadcast content B scheduled at the current time, transmit identification information on the broadcast content B and information on the current time of playback to the broadcast content providing server 200 by referring to the URL of the broadcast content providing server 200 stored in the memory 130. The identification information on the broadcast content B may be title, identification (ID), identification number, and the like of broadcast content B, and the current time of playback information may be the progress rate of playback (in FIG. 3A, because the total playback time of the broadcast content B is 13:00 to 14:00 which is 60 minutes and the current time is 13:15, the rate of progress may be 25%) of the broadcast content B, but the embodiment is not limited thereto.

Accordingly, the broadcast content providing server 200 may provide the broadcast content B to the display apparatus in a streaming method from the time of playback corresponding to the current time 30 (e.g., 13:15).

Based on the identification, if the broadcast content scheduled at the current time is not present, the processor 120 may identify an empty schedule period that starts from the current time on the broadcasting schedule of the selected channel. Specifically, the processor 120 may identify a period from the current time to the playback start time of the next broadcast content with the fastest playback start time based on the current time as an empty schedule period on the broadcasting schedule of the selected channel.

For example, in FIG. 3A, if channel number 503 is selected, the processor 120 may identify whether a broadcast content with the current time 30 (e.g., 13:15) included is present in-between the playback start time and the playback end time on the broadcasting schedule of the channel number 503, and identify that there is no broadcast content scheduled at the current time 30.

Accordingly, the processor 120 may identify a period x from the current time 30 to the playback start time 40 of the next broadcast content I with the fastest playback start time based on the current time 30 as an empty schedule period on the broadcasting schedule of the selected channel number 503.

Based on an empty schedule period being identified, the processor 120 may identify one of the plurality of contents and control the display to playback the identified content based on the empty schedule period and the playback time of the plurality of contents included in the content list received from the broadcast content management server 400.

Specifically, the processor 120 may identify one content with a playback time of a length corresponding to the empty schedule period among the plurality of contents included in the content list, and control the display 140 to playback the identified content in the empty schedule period.

As described above, the broadcast content management server 400 may manage a plurality of insert contents with playback times of different lengths from one another capable of being inserted in the empty schedule period and a list on the plurality of insert contents. According to an embodiment, the content list may include information on the details of the plurality of insert contents and information on the playback time of each of the plurality of insert contents.

FIG. 3B is an exemplary view illustrating a content list according to an embodiment of the disclosure. As illustrated in FIG. 3B, the content list may include information on the category of the insert content and information on the details and the playback time, but the embodiment is not limited thereto.

According to an embodiment, the insert content included in the content list may be at least one of an advertisement image content, a promotional image content on a channel selected by the administrator of the broadcast schedule table management server 300 among the plurality of promotional image contents promoting each channel of the live streaming broadcast service, and a use guide image content of the display apparatus 100, but the embodiment is not limited thereto. In the case of the content list in FIG. 3B, the content list includes insert contents of 3 types of categories such as advertisement, channel promotion and use guide.

Accordingly, the processor 120 may identify an insert content with a playback time corresponding to an empty schedule period on the content list, and playback the identified insert content in the empty schedule period. The playback time corresponding to the empty schedule period may refer to a playback time which is the same as the empty schedule period or a playback time shorter than the empty schedule period by a predetermined time.

The processor 120 may request the identified insert content to the broadcast content management server 400, and receive the identified insert content from the broadcast content management server 400 in a streaming method and playback the received content. In addition, if the identified insert content is stored in the memory 130, the insert content stored in the memory 130 may be played back.

In the example of FIGS. 3A and 3B, if the empty schedule period x is 10 minutes, the processor 120 may identify a sports channel promotional image content with a playback time the same as the empty schedule period (i.e., 10 minutes) on the content list, and playback the sports channel promotional image content in the empty schedule period.

In FIG. 3B, the case of the playback time of the insert contents being all different from one another has been illustrated, but the embodiment is not limited thereto. According to an embodiment, the plurality of insert contents may include a plurality of insert contents with the same playback times. In this case, the processor 120 may identify one insert content of the plurality of insert contents with the same playback times based on a priority order pre-assigned by the administrator of the broadcast schedule table management server 300 or the administrator of the broadcast content management server 400, or the priority order predetermined by the user of the display apparatus 100. The priority order may be assigned to each insert content, or to a category to which the insert content belong.

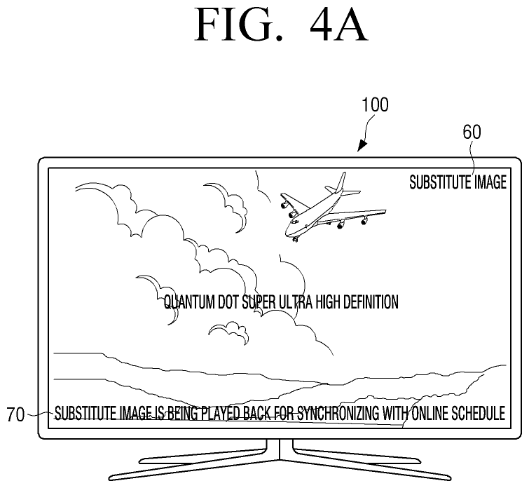

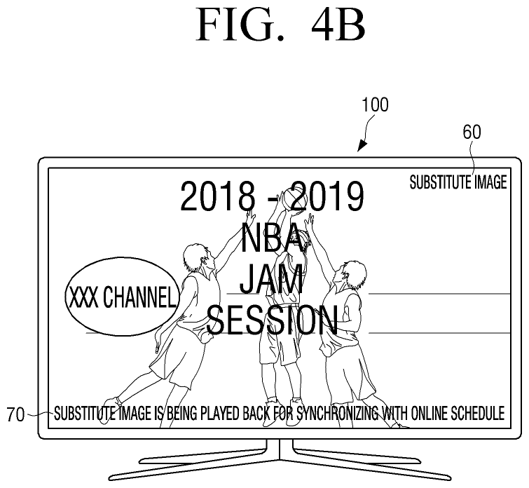

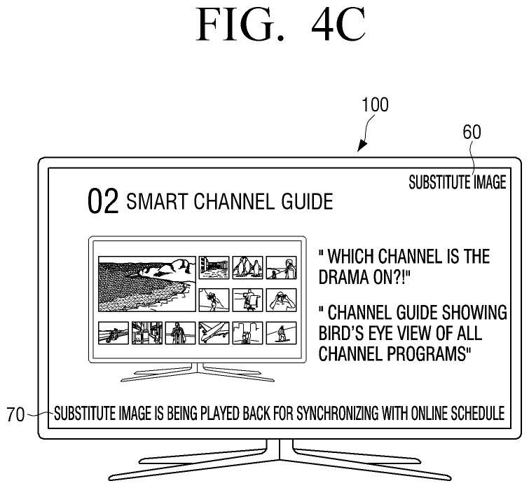

FIGS. 4A to 4C illustrate an insert content playback screen according to the various embodiments of the disclosure. Specifically, FIG. 4A illustrates a playback screen of a TV advertisement image content according to an embodiment of the disclosure, FIG. 4B illustrates a playback screen of a sports channel promoting image content according to an embodiment of the disclosure, and FIG. 4C illustrates a playback screen of a use guide image content of a display apparatus according to an embodiment of the disclosure.

In each of the insert contents being played back, a UI representing that the corresponding image is a substitute image to be displayed in the empty schedule period may be included for user convenience. Reference numerals 60 and 70 of FIGS. 4A to 4C illustrate examples of the UI.

Even if the broadcast content is present on the broadcasting schedule of the selected channel, there may be cases where the broadcast content may not be played back such as an error being present on the received broadcast content file, the location information of the broadcast content providing server 200 being wrong, or the like. According to an embodiment, the processor 120 may, even in cases like the above, identify the empty schedule period and control the display 140 to playback the identified content in the empty schedule period as described above.

According to an embodiment, the broadcast schedule table management server 300 may manage the location information of a plurality of broadcast content providing servers 200 with respect to one broadcast content. The processor 120 may identify whether the broadcast content may be received from the plurality of broadcast content providing servers 200 based on the priority order on the plurality of broadcast content providing servers 200, and if the broadcast content may not be received from the plurality of broadcast content providing servers 200, determine the broadcast content as not capable of playback.

In the example of FIG. 3A, if a user selects channel number 501, the processor 120 may identify that the broadcast content B scheduled at the current time 30 is present. Accordingly, although the processor 120 intended to receive the broadcast content B from the broadcast content providing server 200 which provides the broadcast content B and playback the received content, the processor 120 may not be able to playback the broadcast content B for reasons such as not being able to receive the broadcast content B due to wrong URL information of the broadcast content providing server 200 or there being problem with the received file despite receiving the broadcast content B from the broadcast content providing server 200. In this case, the processor 120 may identify the period from the current time 30 to the playback start time (i.e., 14:00) of the next broadcast content C as an empty schedule period, and playback the insert content corresponding to the empty schedule period in the empty schedule period.

According to an embodiment, as described above, the broadcast content providing server 200 providing a live streaming service on the broadcast content B may be in plurality, such as server 1 and server 2. For example, in server 1 and server 2, a priority order such as primary and secondary may be assigned respectively.

As in the example above, the processor 120 may first receive the broadcast content B from server 1 and attempt playback, and when having failed, may again attempt to receive the broadcast content B from server 2 and playback the received content. By establishing a plurality of methods in providing the live streaming service and attempting sequential connection, the probability of not being able to provide service due to connection errors and the like to the broadcast content providing server 200 may be significantly reduced.

If playback of the broadcast content B with respect to both server 1 and server 2 fails, the processor 120 may determine the broadcast content B as not capable of playback, and perform the identifying of the empty schedule period and the process of playing back the inserted content.

According to an embodiment, at each time the playback of the broadcast content ends, the display apparatus 100 may identify whether the broadcast content scheduled at the current time on the broadcast schedule table is present, and operate as described above based on the results of the identification. When the playback of the broadcast content is completed, the processor 120 may identify whether the broadcast content scheduled after completion of the playback is present on the broadcasting schedule of the selected channel.

An overlapping of the playback time of the broadcast content being played back and the playback time of the next scheduled order of the broadcast content may occur for reasons such as the actual playback time of the broadcast content and the playback time on the broadcast schedule table being different. According to an embodiment, the processor 120 may identify if the playback time of the broadcast content currently being played back and the playback time of the next scheduled broadcast content overlaps, and if the playback times overlap, inquire as to which broadcast content to view to the user prior to the playback start time of the next scheduled broadcast content and promote user convenience.

If the playback start time of the broadcast content scheduled next of the broadcast content being played back arrives within a predetermined time range from the current time (i.e., the current time refers to the current time at which the broadcast content of a selected channel is being played back and not the current time at which the live streaming broadcast channel is selected) on the broadcasting schedule of the selected channel in the broadcast schedule table while playing back the live streaming broadcast content of a specific channel, the processor 120 may identify the playback end time of the broadcast content being played back.

That is, the processor 120 may identify the actual playback end time of the broadcast content being played back prior to a predetermined time (e.g., 10 seconds) before the playback start time of the next scheduled broadcast content on the broadcast schedule table arrives. Specifically, the processor 120 may receive information on the actual total playback time of the broadcast content when receiving the broadcast content from the broadcast content providing server 200. Accordingly, the processor 120 may determine by what percent the current playback section is in progress from the actual total playback period, and identify or calculate the actual playback end time of the broadcast content being played back.

Accordingly, if the identified playback end time is later than the playback start time of the next scheduled broadcast content, the processor 120 may control the display 140 to display a UI inquiring whether to view or record the next scheduled broadcast content.

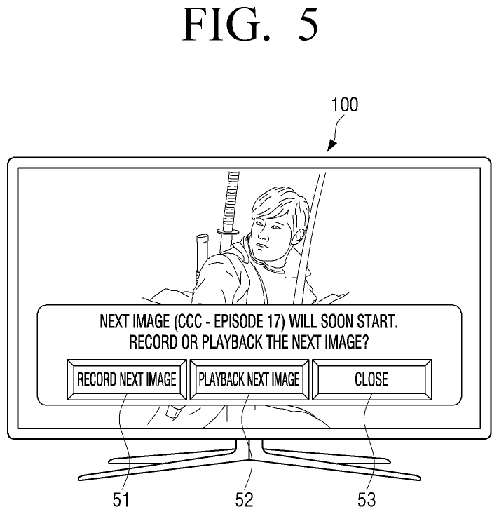

FIG. 5 is an exemplary view illustrating a UI inquiring whether to view or record according to an embodiment of the disclosure. Referring to FIG. 5, the UI inquiring whether to view or record may include a plurality of icons (or, UI elements) such as record next image 51, playback next image 52, and close 53.

Specifically, the record next image 51 is an icon for recording the next broadcast content in the background while continuously viewing the broadcast content currently being played back, when the playback start time of the next broadcast content arrives. The playback next image 52 is an icon for viewing the next broadcast content without viewing the broadcast content currently being played back. The close 53 is an icon for continuously viewing the broadcast content currently being played back without recording the next broadcast content, when the playback start time of the next broadcast content arrives.

The user may, based on selecting each icon, operate the display apparatus 100 according to a desired method, when the playback start time of the next broadcast content arrives.

According to an embodiment, when the playback next image 52 is selected, the next broadcast content may be played back and the playback of the previous broadcast content terminates when the playback start time of the next broadcast content arrives, and information on the playback end position of the previous broadcast content may be stored. Accordingly, when a user views the previous broadcast content in video on demand (VOD) at a later time, the previous broadcast content in which the playback has terminated may be continued following from the position where the playback was terminated.

Alternatively, according to another embodiment, if the playback next image 52 is selected, the display apparatus 100 may playback the next broadcast content while recording the previous broadcast content being played back, when the playback start time of the next broadcast content arrives.

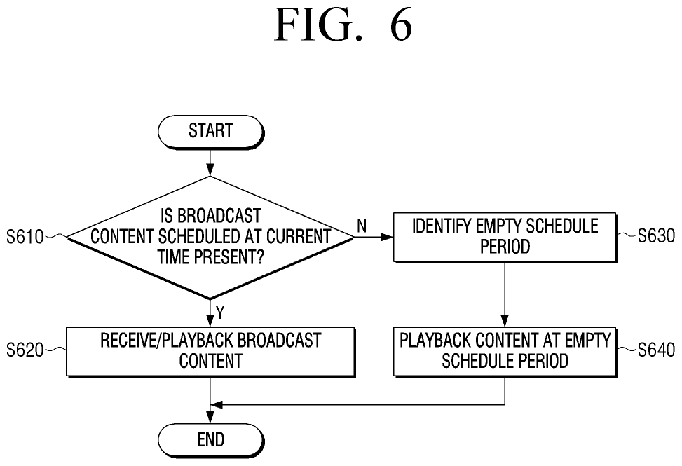

FIG. 6 is a flowchart illustrating a control method of a display apparatus according to an embodiment of the disclosure. Referring to FIG. 6, the display apparatus 100 may, based on a channel to which a live streaming broadcast service is provided being selected, identify whether a broadcast content scheduled at a current time is present on the broadcasting schedule of the selected channel in the broadcast schedule table including the broadcasting schedules for each channel of the live streaming broadcast service (S610).

Specifically, the display apparatus 100 may identify whether a broadcast content with the current time included in-between the playback start time and the playback end time is present on the broadcasting schedule of the selected channel to identify whether the broadcast content scheduled at the current time is present.

Based on identification, if the broadcast content scheduled at the current time is present (S610, Y), the display apparatus 100 may receive, from the broadcast content providing server 200, the broadcast content from the time of playback corresponding to the current time of a total playback time in a streaming method and playback the received content (S620).

If there is no broadcast content scheduled at the current time (S610, N), the display apparatus 100 may identify an empty schedule period stating from the current time on the broadcasting schedule of the selected channel (S630).

Specifically, the display apparatus 100 may, based on there being no scheduled broadcast content present at the current time, identify the period from the current time to the playback start time of the next broadcast content with the fastest playback start time based on the current time as an empty schedule period on the broadcasting schedule of the selected channel.

Accordingly, the display apparatus 100 may identify an empty schedule period and one of the plurality of contents based on the playback times of the plurality of contents with different playback times from one another, and playback the identified content (S640). The identified content may be one of an advertisement image content, a promotional image content on a channel selected by an administrator of a server that manages the broadcast schedule table among the plurality of promotional image contents promoting each channel of the live streaming broadcast service, and a use guide image content of the display apparatus.

Specifically, the display apparatus 100 may identify one content with a playback time of a length corresponding to an empty schedule period of the plurality of contents, and playback the identified content in the empty schedule period.

According to an embodiment, the display apparatus 100 may, based on the playback of the broadcast content being completed, identify whether a broadcast content scheduled after the completion of the playback is present on the broadcasting schedule of the selected channel of the broadcast schedule table.

In addition, while receiving the broadcast content and playing back the received content, the display apparatus 100 may identify the playback end time of the broadcast content being received if the playback start time of the next scheduled broadcast content of the broadcast contents on the broadcasting schedule of the selected channel arrives within a predetermined time range from the current time. Accordingly, if the playback end time is later than the playback start time of the next scheduled broadcast content, the display apparatus 100 may display a UI inquiring whether to view or record the next scheduled broadcast content.

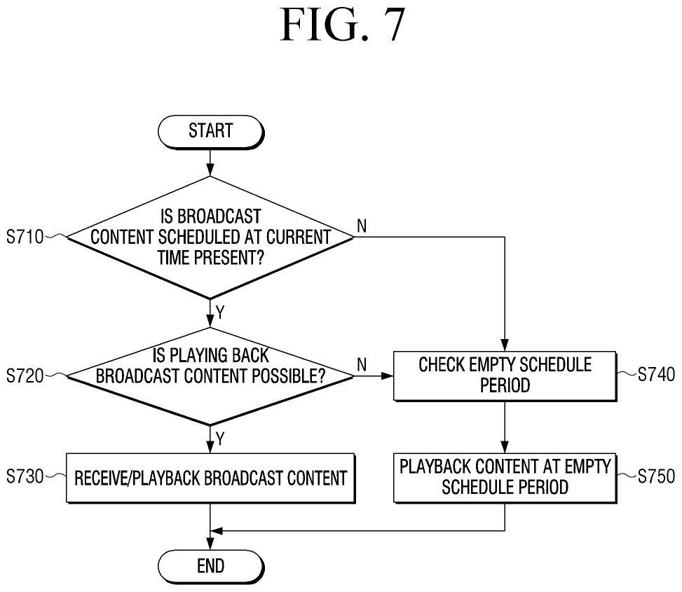

FIG. 7 is a flowchart illustrating a control method of a display apparatus according to another embodiment of the disclosure. Referring to FIG. 7, the display apparatus 100 may, based on a channel to which a live streaming broadcast service is provided being selected, identify whether the broadcast content scheduled at the current time is present on the broadcasting schedule of the selected channel in the broadcast schedule table which includes the broadcasting schedules for each channel of the live streaming broadcast service (S710).

Upon identification, if the broadcast content scheduled at the current time is present (S710, Y), the display apparatus 100 may identify whether playing back the broadcast content scheduled at the current time is possible (S720).

If the broadcast content scheduled at the current time may be played back (S720, Y), the display apparatus 100 may receive, from the broadcast content providing server 200, the broadcast content from the time of playback corresponding to the current time of a total playback time of the broadcast content in a streaming method and playback the received content (S730).

If the broadcast content scheduled at the current time is not present (S710, N) or may not be played back even if present (S720, N), the display apparatus 100 may identify the empty schedule period (S740), identify the empty schedule period and one of the plurality of contents based on the playback time of the plurality of contents having playback times of different lengths from one another, and playback the identified content in the empty schedule period (S750).

According to an embodiment, if the server providing the broadcast content scheduled at the current time is in plurality, the display apparatus 100 may identify whether the broadcast content scheduled at the current time may be received from the plurality of servers based on a priority order on the plurality of servers, and if the broadcast content scheduled at the current time may not be received from the plurality of servers, the display apparatus 100 may determine that the broadcast content scheduled at the current time is not capable of playback.

According to the various embodiments of the disclosure, even in cases of a schedule being empty on the broadcast schedule table or the broadcast content not being able to be played back according to the broadcast schedule table occurring, user inconvenience and confusion may be minimized since the live streaming broadcast service may be provided while maintaining the existing broadcast schedule table.

The various embodiments of the disclosure may be implemented as a software including instructions stored in a machine-readable storage medium (e.g., computer). The machine may call an instruction stored in the storage medium, and as a device capable of operating according to the called instruction, may include the display apparatus 100 according to the embodiments disclosed above.

Based on the instructions being executed by the processor, the processor may perform, directly or under the control of the processor, a function corresponding to the instruction using different elements. The instructions may include a code generated by a compiler or executed by an interpreter. The machine-readable storage media may be provided in the form of a non-transitory storage medium. Herein, ‘non-transitory’ merely means that the storage medium is tangible and does not include a signal and does not distinguish that data is permanently or temporarily stored in the storage medium.

According to an embodiment, a method according to one or more embodiments may be provided in a computer program product. The computer program product may be exchanged between a seller and a purchaser as a commodity. The computer program product may be distributed in the form of a machine-readable storage medium (e.g., a compact disc read only memory (CD-ROM)), or distributed online through an application store (e.g., PLAYSTORE™). In the case of online distribution, at least a portion of the computer program product (e.g., downloadable app) may be at least stored temporarily in a storage medium such as a manufacturer's server, a server of an application store, or a memory of a relay server, or temporarily generated.

According to various embodiments, each of the elements (e.g., module or program) may be configured as a single entity or a plurality of entities, and some sub elements of the corresponding sub elements described above may be omitted, or another sub-element may be further included. Alternatively or additionally, some elements (e.g., modules or programs) may be integrated into one entity to perform the same or similar functions performed by each respective element prior to integration. The module, program, or operations executed by other elements according to variety of embodiments may be executed consecutively, in parallel, repeatedly, or heuristically, or at least some operations may be executed according to a different order, may be omitted, or other operations may be added thereto.

While the present disclosure has been illustrated and described with reference to various example embodiments thereof, the present disclosure is not limited to the specific embodiments described. It will be understood by those skilled in the art that various changes in form and details may be made therein without departing from the spirit and scope of the disclosure.

What is claimed is:

1. A display apparatus, comprising:
a display;
a communicator;
a memory storing a broadcast schedule table comprising a broadcasting schedule for each channel of a live streaming broadcast service and a content list on a plurality of contents with playback times of different lengths from one another; and
a processor configured to:
based on a channel to which a live streaming broadcast service is provided being selected, identify whether a broadcast content scheduled at a current time is present on a broadcasting schedule of the selected channel in the broadcast schedule table;
based on the broadcast content being present, control the communicator to receive, from a server providing the broadcast content, the broadcast content from a time of playback corresponding to the current time of a total playback time of the broadcast content in a streaming method; and
control the display to playback the broadcast content received in the streaming method,
wherein the processor is configured to, based on the broadcast content not being present, identify an empty schedule period starting from the current time on the broadcasting schedule of the selected channel, identify one of the plurality of contents based on the empty schedule period and playback times of the plurality of contents included in the content list, and control the display to playback the identified content.

2. The display apparatus of claim 1, wherein the processor is configured to identify one content with a playback time of a length corresponding to the empty schedule period among the plurality of contents, and control the display to playback the identified content at the empty schedule period.

3. The display apparatus of claim 1, wherein the processor is configured to identify whether a broadcast content in which the current time is between a playback start time and a playback end time on the broadcasting schedule of the selected channel is present to identify whether the broadcast content scheduled at the current time is present.

4. The display apparatus of claim 1, wherein the processor is configured to, based on the broadcast content not being present, identify a period from the current time to a playback start time of a next broadcast content with a closest playback start time based on the current time as the empty schedule period on the broadcasting schedule of the selected channel.

5. The display apparatus of claim 1, wherein the processor is configured to, based on the broadcast content being present on the broadcasting schedule of the selected channel but not being able to playback the broadcast content, identify the empty schedule period, and control the display to playback the identified content at the empty schedule period.

6. The display apparatus of claim 5, wherein the processor is configured to:
based on a server providing the broadcast content being in plurality, identify whether the broadcast content is receivable from a plurality of servers based on a priority order on the plurality of servers; and
based on not being able to receive the broadcast content from the plurality of servers, determine the broadcast content as not being able to playback.

7. The display apparatus of claim 1, wherein the identified content is at least one of an advertisement image content, a promotional image content on a channel selected by an administrator of a server that manages the broadcast schedule table among the plurality of promotional image contents promoting each channel of the live streaming broadcast service, and a use guide image content of the display apparatus.

8. The display apparatus of claim 1, wherein the processor is configured to:
while playing back the received broadcast content on the display, when a playback start time of a broadcast content scheduled in following order of the received broadcast content on the broadcasting schedule of the selected channel arrives within a predetermined time range from the current time, identify a playback end time of the received broadcast content; and
based on the playback end time being later than a playback start time of the next scheduled broadcast content, control the display to display a user interface (UI) inquiring whether to view or record the next scheduled broadcast content.

9. The display apparatus of claim 1, wherein the processor is configured to, based on completing playback of the received broadcast content, identify whether a broadcast content scheduled after the completion of the playback is present on the broadcasting schedule of the selected channel on the broadcast schedule table.

10. A control method of a display apparatus, the control method comprising:
based on a channel to which a live streaming broadcast service is provided being selected, identifying whether a broadcast content scheduled at a current time is present on a broadcasting schedule of the selected channel in a broadcast schedule table comprising broadcasting schedules for each channel of the live streaming broadcast service;
based on the broadcast content being present, receiving, from a server providing the broadcast content, the broadcast content from a time of playback corresponding to the current time of a total playback time of the broadcast content in a streaming method and playing back the received content;
based on the broadcast content not being present, identifying an empty schedule period starting from the current time on the broadcasting schedule of the selected channel; and
identifying one of a plurality of contents based on the empty schedule period and playback times of the plurality of contents with playback times of different lengths from one another and playing back the identified content.

11. The control method of claim 10, wherein the playing back the identified content comprises identifying one content with a playback time of a length corresponding to the empty schedule period among the plurality of contents, and playing back the identified content at the empty schedule period.

12. The control method of claim 10, wherein the identifying whether the broadcast content is present comprises identifying whether a broadcast content in which the current time is between a playback start time and a playback end time on the broadcasting schedule of the selected channel is present to identify whether the broadcast content scheduled at the current time is present.

13. The control method of claim 10, wherein the identifying the empty schedule period comprises, based on the broadcast content not being present, identifying a period from the current time to a playback start time of a next broadcast content with a closest playback start time based on the current time as the empty schedule period on the broadcasting schedule of the selected channel.

14. The control method of claim 10, further comprising:
based on the broadcast content being present on the broadcasting schedule of the selected channel but not being able to playback the broadcast content, identifying the empty schedule period, and playing back the identified content at the empty scheduled period.

15. The control method of claim 14, further comprising:
based on a server providing the broadcast content being in plurality, identifying whether the broadcast content is receivable from a plurality of servers based on a priority order on the plurality of servers; and
based on not being able to receive the broadcast content from the plurality of servers, determining the broadcast content as not being able to playback.

16. The control method of claim 10, wherein the identified content is at least one of an advertisement image content, a promotional image content on a channel selected by an administrator of a server that manages the broadcast schedule table among a plurality of promotional image contents promoting each channel of the live streaming broadcast service, and a use guide image content of the display apparatus.

17. The control method of claim 10, further comprising:
while receiving the broadcast content and playing back the received content, when a playback start time of a broadcast content scheduled in following order of received the broadcast content on the broadcasting schedule of the selected channel arrives within a predetermined time range from the current time, identifying a playback end time of the received broadcast content; and
based on the playback end time being later than a playback start time of the next scheduled broadcast content, displaying a UI inquiring whether to view or record the next scheduled broadcast content.

18. The control method of claim 10, further comprising:
based on completing playback of the broadcast content, identifying whether a broadcast content scheduled after the completion of the playback is present on the broadcasting schedule of the selected channel of the broadcast schedule table.

19. A non-transitory computer readable medium comprising a program for executing a control method of a display apparatus, the method comprising:
based on a channel to which a live streaming broadcast service is provided being selected, identifying whether a broadcast content scheduled at a current time is present on a broadcasting schedule of the selected channel in a broadcast schedule table comprising broadcasting schedules for each channel of the live streaming broadcast service;
based on the broadcast content being present, receiving, from a server providing the broadcast content, the broadcast content from a time of playback corresponding to the current time of a total playback time of the broadcast content in a streaming method and playing back the received content;
based on the broadcast content not being present, identifying an empty schedule period starting from the current time on the broadcasting schedule of the selected channel; and
identifying one of the plurality of contents based on the empty schedule period and playback times of the plurality of contents with playback times of different lengths from one another and playing back the identified content.
